(19) United States
(12) Patent Application Publication
(10) Pub. No.: US 2004/0242070 A1
(43) Pub. Date: Dec. 2, 2004

(54) Electrical connector assembly, receptacle connector and plug connector

(76) Inventors: Masashi Inoue, Kanagawa (JP); Naotaka Sasame, Saitama (JP)

Correspondence Address: BARLEY SNYDER, LLC, 1000 WESTLAKES DRIVE, SUITE 275, BERWYN, PA, 19312, US

(21) Appl. No.: 10/854,697

(22) Filed: May 26, 2004

(30) Foreign Application Priority Data
May 28, 2003 (JP) 2003-150464
Aug. 18, 2003 (JP) 2003-294137

(51) Int. Cl. H01R 13/73

(52) U.S. Cl. 439/607

(57) ABSTRACT

An electrical connector assembly, a receptacle connector and a plug connector are provided, wherein a comparatively low engagement holding force is maintained over an extremely large number of insertions and extractions. The outer appearances of the connectors are also maintained by preventing marks, due to the insertion and extraction. The electrical connector assembly comprises the receptacle connector and the plug connector. The receptacle connector and the plug connector respectively comprise locking portions that lock to each other with a low engagement holding force during engagement. The receptacle connector further comprises press contacting protrusions, for frictionally contacting the plug connector, and serves to prevent extraction.

### FIELD OF THE INVENTION

The present invention relates to an electrical connector assembly for use in electronic devices, and to a receptacle connector and a plug connector, employed in the electrical connector assembly.

### BACKGROUND OF THE INVENTION

Electrical connector assemblies with locking mechanisms to lock the connectors to each other, are used in a variety of electronic devices. For example, U.S. Pat. No. 5,879,194 provides an electrical connector assembly comprising a socket (receptacle connector) which has a metallic shielding member at its exterior, and a plug (plug connector) for engaging with the socket. Locking protrusions comprising hooks are formed on the shield member of the socket. The hooks are configured to engage apertures, which are formed in the plug during engagement of the socket and the plug. To release the engagement, the locking protrusions are pressed.

In the electrical connector assembly disclosed in U.S. Pat. No. 5,879,194, the engaged state of the socket and plug is maintained by the positive engagement between the hooks and the apertures. However, if an excessive force is applied in the extraction direction of the plug while in the engaged state, the locking protrusions (hooks) and/or the apertures may be damaged.

The application of excessive force occurs accidentally during normal use of electronic devices. For example, it is possible for a headphone cord to get caught on something, while listening to music with a Mini Disc player through headphones. Cords for other devices may also get caught on things, such as when listening to music downloaded to a cellular telephone through earphones, recharging a digital camera, and when connecting cords in general. As a result, external force is applied to the cord, which then leads to an excessive extraction force being exerted on connectors. This, in turn, may lead to damaging the locking portions of the connectors, or of dropping and damaging the device itself. For this reason, connectors of this type, so-called multimedia interface connectors, are manufactured with predetermined design standards that assume that excessive external force will be applied thereto.

Specifically, connectors are designed to have engagement holding forces within a predetermined range (5N to 10N, for example). In the case that an external force, that is, an extraction force, over a certain load is applied, the connectors are to separate without damage thereto. It is desired that connectors are designed to withstand 10,000 cycles of a continuous insertion/extraction test, so that the above function is not lost during the product lifetime.

### SUMMARY OF THE INVENTION

In view of the above circumstances, the present invention provides an electrical connector assembly, a receptacle connector, and a plug connector that maintain a comparatively low engagement holding force over an extremely large number of insertions and extractions, thereby releasing the engagement (lock) between the connectors in the case that a large external force is applied.

The of the present invention comprises:

a first connector having a first insulative housing for holding at least one first contact; and

a second connector having a second insulative housing for holding second contacts that contact the first contact during engagement with the first connector; wherein:

locking portions on the first and second connectors for locking with each other during engagement with a low engagement holding force; and

protrusions for frictionally contacting the second connector are provided on the first connector.

### BRIEF DESCRIPTION OF THE DRAWINGS

FIG. 1 is a front perspective view of a receptacle connector for use in a locking connector assembly according to an exemplary embodiment of the present invention.

FIG. 2 is a rear perspective view of the receptacle connector of FIG. 1.

FIG. 3 is a front view of the receptacle connector of FIG. 1.

FIG. 4 is a side view of the receptacle connector of FIG. 1.

FIG. 5 is a plan view of the receptacle connector of FIG. 1.

FIG. 6 is a bottom view of the receptacle connector of FIG. 1.

FIG. 7 is a rear perspective view of a plug connector for use in a locking connector assembly according to an exemplary embodiment of the present invention.

FIG. 8 is a front view of the plug connector of FIG. 7.

FIG. 9 is a side view of the plug connector of FIG. 7.

FIG. 10 is a sectional view of the plug connector of FIG. 7, taken along line X-X in FIG. 8.

FIG. 11 is a partial sectional view of a locking connector assembly according to an exemplary embodiment of the present invention, showing a state in which a plug connector and a receptacle connector are completely engaged.

FIG. 12 is a perspective view of a modified receptacle connector according to an alternative exemplary embodiment of the present invention.

FIG. 13 is a perspective view of a plug connector for a locking connector assembly according to another alternate exemplary embodiment of the present invention.

FIG. 14A and FIG. 14B show a receptacle connector, which is to be engaged with the plug connector of FIG. 13, wherein FIG. 14A is a front perspective view and FIG. 14B is a bottom view.

FIG. 15 is a vertical sectional view of an electrical connector assembly comprising the plug connector of FIG. 13 and the receptacle connector of FIGS. 14A and 14B, showing a state in which the receptacle connector and the plug connector are completely engaged.

### DETAILED DESCRIPTION OF THE INVENTION

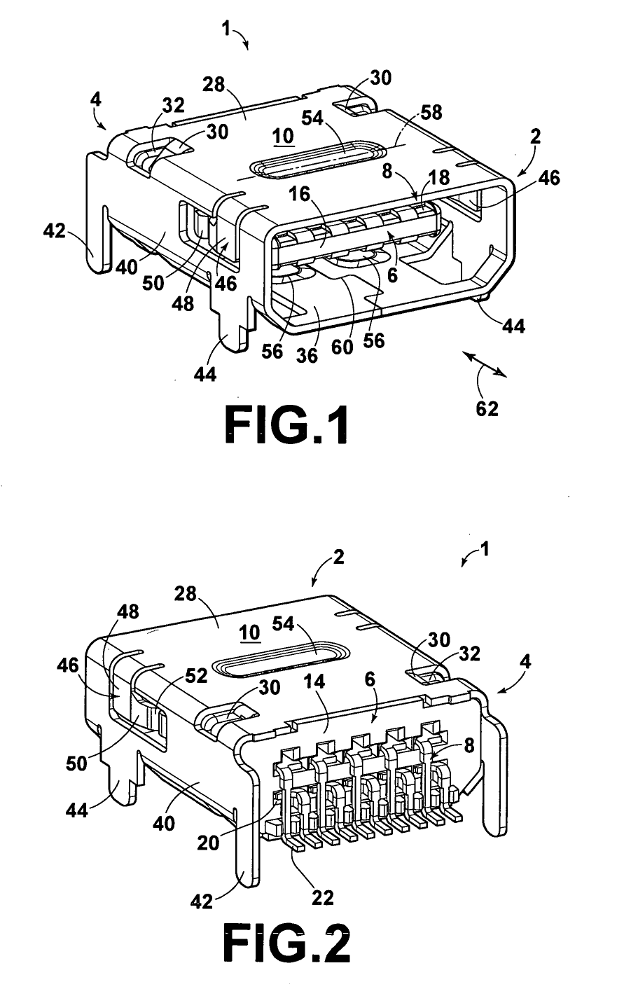

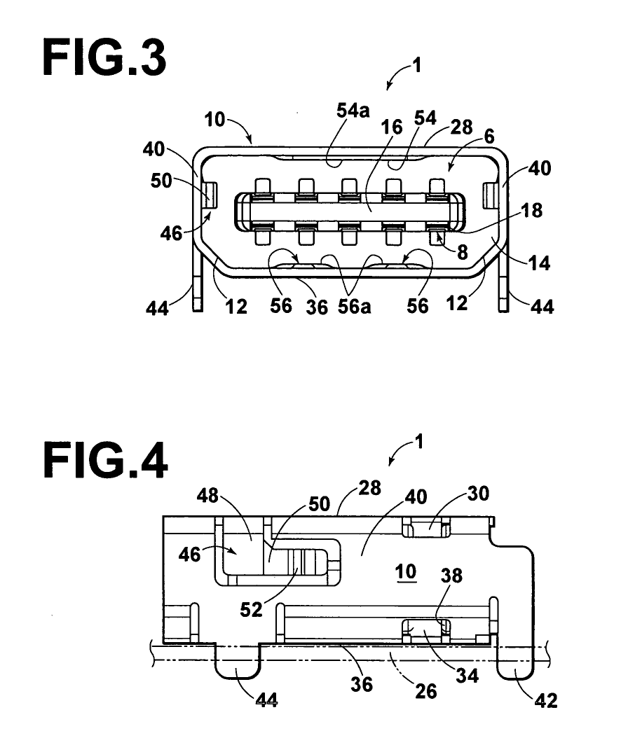

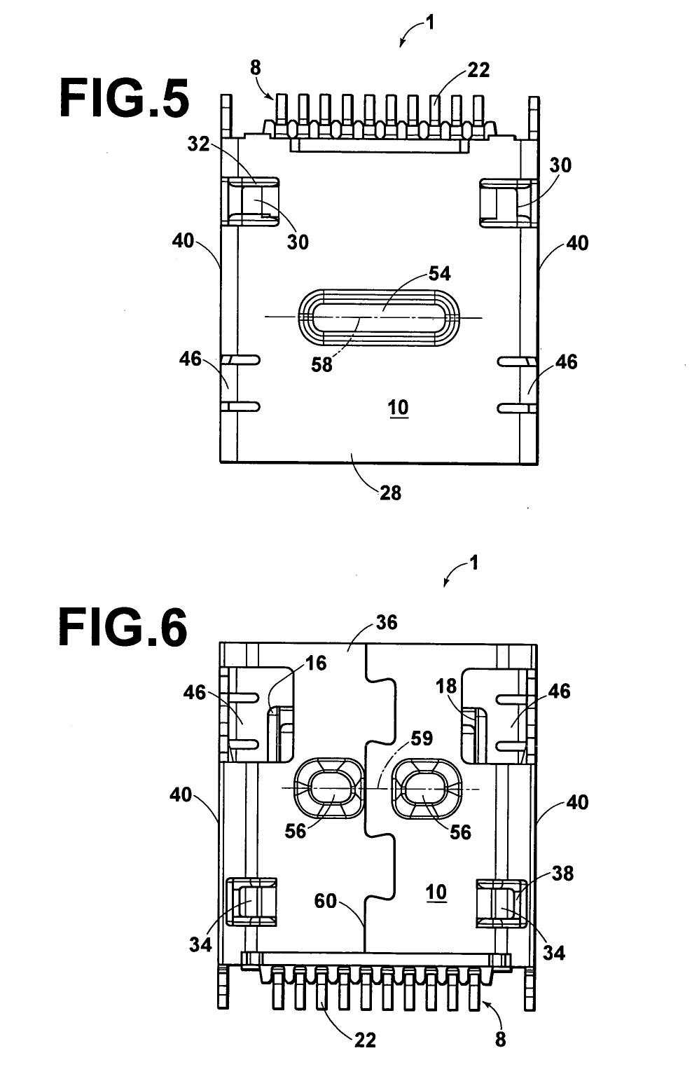

Hereinafter, preferred embodiments of an electrical connector assembly C (hereinafter, simply referred to as “assembly”), the receptacle connector, and the plug connector will be described with reference to the attached drawings. FIG. 1 is a front perspective view of a receptacle connector 1, which is the first connector of the assembly C. FIG. 2 is a rear perspective view of the receptacle connector 1. FIG. 3 is a front view, FIG. 4 is a side view, FIG. 5 is a plan view, and FIG. 6 is a bottom view of the receptacle connector 1. Hereinafter, a description will be given with reference to FIG. 1 through FIG. 6.

The receptacle connector 1 comprises: an insulative housing 6 (hereinafter, simply referred to as “housing”); first contacts 8, which are held by the housing 6; and a shielding member comprising a shell 10, which is provided so as to cover the periphery of the housing 6, leaving an opening at front end 2.

As most clearly illustrated in FIG. 3, the housing 6 comprises a main body 14 having a substantially rectangular shape when viewed from the front. Tapers 12 are formed at both lower corners of the main body 14. A contact supporting plate 16 protrudes from the front end 2 of the main body 14. A plurality of contact receiving grooves 18 are provided at predetermined intervals in the upper and lower surfaces of the contact supporting plate 16. The first contacts 8 are press fit into the contact receiving grooves 18 and placed therein. Each of the first contacts 8 comprises: a tine 22 (shown in FIG. 2) that extends through an aperture 20 toward the rear of the main body 14 to be connected to a circuit board 26 (shown in FIG. 4); and a contacting portion 24 for contacting second contacts 104 (best shown in FIG. 8), which will be described later.

Next, the shell 10 will be described. The shell 10 may be formed, for example, by stamping and forming a single conductive metal plate into a shape that surrounds the periphery of the main body 14. The ends of the shell 10 abut each other at a seam 60 (shown in FIG. 6), to house the entirety of the housing 6 therein. The seam 60 is formed as a dovetail joint, which causes it to be difficult for the ends of the shell 10 to become separated. Tongue pieces 30 are formed at both sides of an upper wall 28 of the shell 10, toward a rear end 4 thereof. The tongue pieces 30 are formed by stamping, and are of a cantilevered structure having their fixed ends at the upper wall 28. The tongue pieces 30 are formed perpendicular to an insertion/extraction direction 62 (shown in FIG. 1), and are bent inwardly. Recesses 32 are formed in the main body 14 at positions corresponding to the tongue pieces 30, and the tongue pieces 30 engage the interiors of the recesses 32. Tongue pieces 34, which are similar to the tongue pieces 30, are formed at a bottom wall 36 of the shell 10, and engage recesses 38, which are formed in the lower portion of the main body 14. The shell 10 is fixed to the housing by the engagement of the tongue pieces 30 and 34 with the recesses 32 and 38.

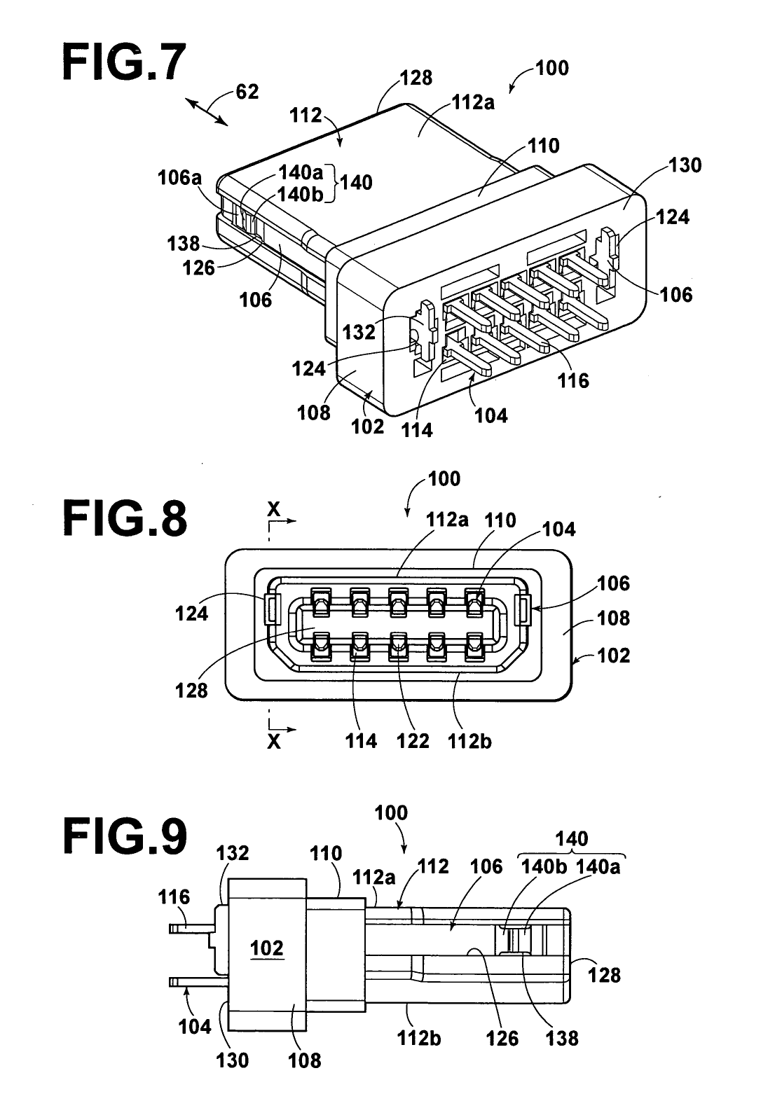

Downwardly extending mounting legs 42 and 44 are formed by cutting and bending the shell 10 at the front and rear of both side walls 40 thereof. The mounting legs 42 and 44 are used for mounting the receptacle connector 1 to the circuit board 26. L-shaped spring pieces 46 are formed by punching out the upper wall 28 and the side walls 40 in the vicinity of the front end 2 of the shell 10. The spring pieces 46 have their fixed ends at the upper wall 28, and are formed symmetrically on the right and left side walls 40 of the shell 10. Each of the spring pieces 46 comprises: an arm 48 that extends from the upper wall 28 through the side wall 40; and an engaging piece 50 that extends rearward from the tip of the arm 48, perpendicular thereto. An engaging protrusion 52 (locking portion) that protrudes inwardly in an arcuate manner is formed on each engaging piece 50. The rear portions of the engaging protrusions 52 function as engaging surfaces 52a (shown in FIG. 11). Here, it is important to note that the engaging protrusions 52 are arcuate in shape, and that they do not have engaging surfaces which are perpendicular to the insertion/extraction direction 62. For this reason, an engagement holding force becomes comparatively low, when the receptacle connector 1 is engaged with a plug connector 100 (refer to FIG. 7), which will be described later.

Next, press contacting protrusions 54 and 56 (beads, best shown in FIGS. 5 and 6), which are characteristic features of the present invention, will be described. The press contacting protrusions 54 and 56 are formed on the upper wall 28 and the lower wall 36 of the shell 10, by inwardly stamping the upper wall 28 and the lower wall 36. The press contacting protrusions 54 and 56 protrude slightly from the upper wall 28 and the lower wall 36 toward the interior of the shell 10, respectively. The dimensions of the press contacting protrusions 54 and 56 are such that they slidingly contact an insulative housing 102 of the plug connector 100 (refer to FIG. 7) when the plug connector 100 and the receptacle connector 1 are engaged with each other. The two press contacting protrusions 56 on the bottom wall 36 are substantially ellipsoid in shape, and are provided on both sides of the seam 60. The press contacting protrusions 54 and 56 have longitudinal axes 58 and 59, respectively. The longitudinal axes 58 and 59 are perpendicular to the insertion/extraction direction 62 of the connectors. The press contacting protrusions 54, 56, and 56 are formed at positions that face each other, to balance the force which is exerted on the insulative housing 102 in the vertical direction.

The longitudinal axes 58 and 59 are perpendicular to the insertion/extraction direction 62. If the longitudinal axes 58 and 59 were parallel to the insertion/extraction direction 62, then the upper surface 112a and the lower surface 112b of the insulative housing 102 would likely be marred. Marring would be particularly likely, where contact portions 54a and 56a (refer to FIG. 3) of the press contacting protrusions 54 and 56 are linear and parallel to the insertion/extraction direction 62. In this case, the upper surface 112a and the lower surface 112b of the insulative housing 102 could become scored, causing linear marks to be formed thereon. This scoring would then decrease the engagement holding force, and also deteriorate the outward appearance of the plug connector 100. Further, shavings from the scoring may become attached to the first contacts 8 and second contacts 104 (refer to FIG. 7), thereby adversely affecting the electrical contact properties therebetween.

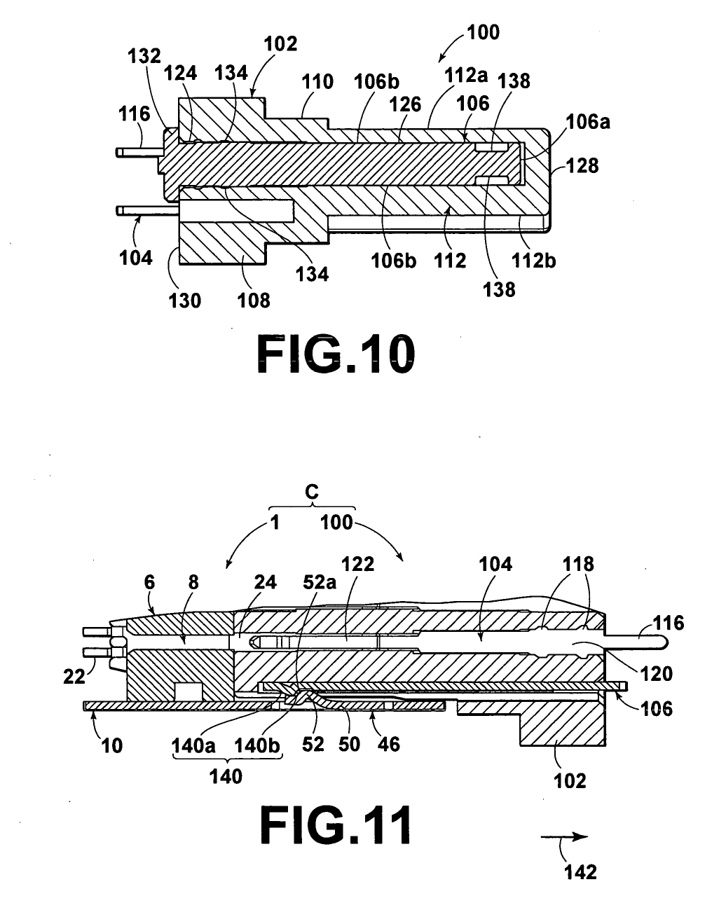

Next, the plug connector 100, which is the second connector, will be described with reference to FIG. 7 through FIG. 10. FIG. 7 is a rear perspective view of the plug connector 100. FIG. 8 is a front view, FIG. 9 is a side view, and FIG. 10 is a sectional view taken along line X-X in FIG. 8, of the plug connector. FIG. 11 is a partial sectional view of the assembly C in a state in which the plug connector 100 and the receptacle connector 1 are completely engaged.

The plug connector 100 comprises: a plastic insulative housing 102 (hereinafter, simply referred to as “housing”); second contacts 104, which are held by the housing 102; and locking pieces 106, which are mounted on both sides of the housing 102. The housing 102 comprises a main body 108, which is shaped as a rectangular block, and an engaging portion 112, which protrudes toward the front via a step 110. Contact apertures 114 are formed in the housing 102, at positions corresponding to those of apertures 20 of the receptacle connector 1. The contact apertures 114 are provided as two rows, which are separated in the vertical direction. The contact apertures 114 penetrate through the housing 102 of the plug connector 100 in a direction parallel to the insertion/extraction direction 62. The second contacts 104 are press fit within the contact apertures 114 from the rear ends thereof. As illustrated in FIG. 11, each of the second contacts 104 comprises: a tine 116 for connecting to a wire (not shown) or a circuit board; a press fit portion 120, which has barbs 118 at both lateral edges thereof; and a contact portion 122 for contacting the contact 8. When the second contacts 104 are press fit into the hosing 102, the barbs 118 frictionally engage with the housing 102, thereby fixing the second contacts 104 to the housing 102.

The locking pieces 106 penetrate apertures 124 formed in a rear surface 130 of the main body 108 of the housing 102 at both sides of the rows of second contacts 104. Locking piece receiving grooves 126 that communicate with the apertures 124 are formed at both sides of the engaging portion 112, parallel to the insertion/extraction direction 62. The locking piece receiving grooves 126 extend to the vicinity of an engagement surface 128. Thus, the tips 106a of the locking pieces 106, which are held within the locking piece receiving grooves 126, are not exposed at the engagement surface 128. The locking piece receiving grooves 126 are of widths that are capable of receiving the lateral edges 106b of the locking pieces 106 therein. As described above, the locking pieces 106 are held by the housing 102 so that neither the tips 106a nor the lateral edges 106b thereof are exposed to the exterior. Therefore, fingers and the like are prevented from contacting the edges of the locking pieces, securing safety. That is, electrical connection requirements can be satisfied while maintaining safety.

Each of the locking pieces 106 comprises: a head or pressing portion 132 at its rear end, that abuts the rear surface 130 of the housing 102; and barbs 134 (refer to FIG. 10) for engaging the housing 102, formed at the lateral edges of the locking piece 106 in the vicinity of its rear end. Cutouts 138 are formed in both lateral edges 106b at the tip of each of the locking pieces 106. Outwardly protruding engaging protrusions 140 (locking portions) are formed at the cutouts 138. Each engaging protrusion 140 comprises: a forward facing inclined surface 140a; and a rearward facing inclined surface 140b. When the plug connector 100 and the receptacle connector 1 are engaged, the engaging protrusions 140 and the engaging protrusions 52 engage each other. This engagement state will be described with reference to FIG. 11.

As clearly illustrated in FIG. 11, the first contacts 8 and the second contacts 104 contact each other, and are frictionally engaged. In addition, the spring pieces 46 and the locking pieces 106 are engaged to each other by the engagement between the engaging protrusions 52 and the engagement protrusions 140, that is, their locking portions. Immediately prior to complete engagement, the spring pieces 46 flex toward the exterior (downward in FIG. 11) due to its elasticity. When the engaging protrusions 52 ride over the engaging protrusions 140, the spring pieces 46 elastically return to engage with the locking pieces 106. Due to this flexure and return, a “click” is generated when complete engagement is achieved. In this engaged state, the inclined surfaces 140b of the lock pieces 106 are engaged with the inclined engaging surfaces 52a of the spring pieces 46. The spring pieces 46 and the locking pieces 106 are both metallic. Therefore, they are capable of forming a conductive electrical path. In the present invention, the shell 10 is grounded to the circuit board 26, thereby-forming an integrated shield (electromagnetic shield).

In addition, the press contacting protrusions 54 and 56 of the receptacle connector 1 slidingly contact the flat upper surface 112a and the flat lower surface 112b of the engaging portion 112 of the plug connector 100 when the connectors are engaged. This contact state is maintained after complete engagement. The frictional force of this contact state also operates as an engagement holding force between the connectors.

If excessive force is exerted on the plug connector 100 in the extraction direction indicated by arrow 142 while in the engaged state, a force is applied on the inclined surfaces 140b that attempts to move them in the direction of arrow 142. This force works to cause the inclined surfaces 140b to flex the engaging surfaces 52a outward. When this force exceeds the engagement holding force of the engaging protrusions 52 and the engaging protrusions 140, the spring pieces 46 are flexed outward to release the engagement, and the plug connector 100 is extracted.

At this time, the engaging protrusions 54 and 56 generate resistance against the excessive force in the extraction direction, by frictionally contacting the housing 102 of the plug connector 100. However, the connectors are designed so that the resistance is not sufficient to prevent extraction. The spring pieces 46 and the locking pieces 106 become worn due to metallic abrasion, after a great number of insertions and extractions. However, the press contacting protrusions 54, 56, and 56 simply contact the plug connector 100 in a sliding manner. Therefore, the press contacting protrusions 54, 56, and 56 are less susceptible to wear. Accordingly, even if the spring pieces 46 and the locking pieces 106 become worn, an engagement holding force of a predetermined amount or greater can be maintained. Further, the possibility that the surface of the hosing 102 of the plug connector 100 will be marred is small, because the press contacting protrusions 54 and 56 have longitudinal axes 58 and 59, which are perpendicular to the insertion/extraction direction 62. In other words, the orientation of the press contacting protrusions 54 and 56 prevent linear marks from being scored into the upper surface 112a and the lower surface 112b of the housing 102. In addition, the frictional engagement between the first contacts 8 and the second contacts 104 also serves to resist extraction. However, in the case that the number of first and second contacts 8 and 104 is small, the frictional force of the press contacting protrusions 54, 56, and 56 are effective in maintaining a predetermined engagement holding force.

As described above, the receptacle connector 1 and the plug connector 100 are designed to have an engagement holding force that is not great enough to damage either when excessive external force is applied to the plug connector. Therefore, damage to the locking portions of the plug connector 100 and the receptacle connector 1 is prevented. Consider a case in which a connected device is a lightweight electronic device such as a cellular telephone. If external force pulls on the connectors and the engagement holding force is too great, the electronic device itself may be pulled off of a table, fall, and be damaged. However, this problem will not occur with the low engagement holding force of the connectors according to the present invention.

A preferred embodiment of the present invention has been described above. However, the present invention is not limited to the above embodiment. It goes without saying that various changes and modifications are capable for those skilled in the art.

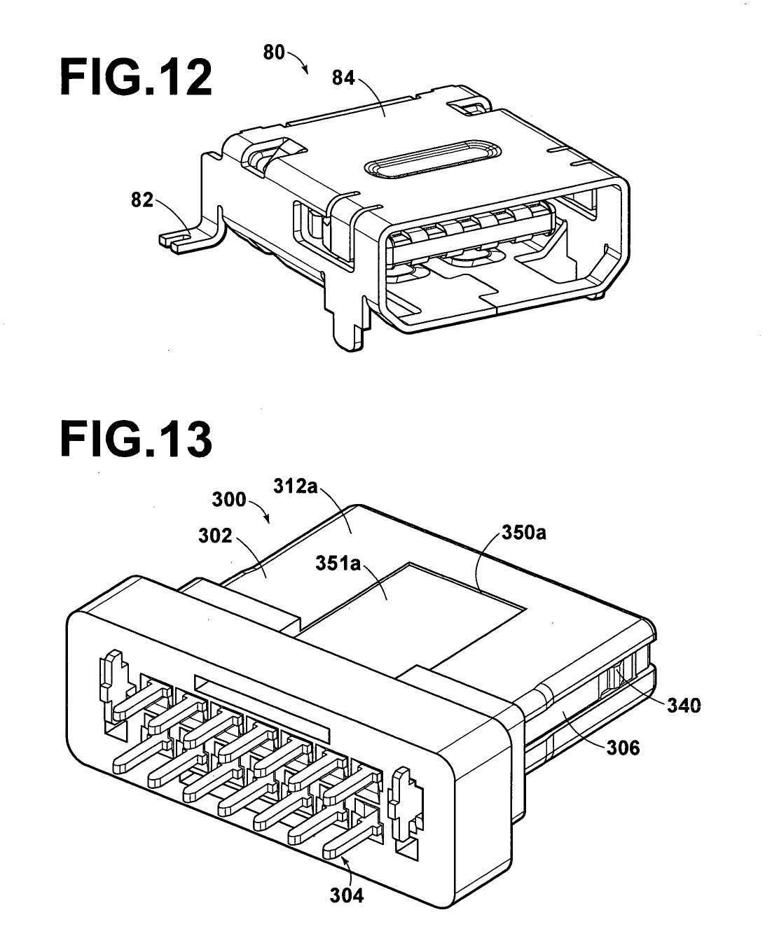

For example, FIG. 12 is a perspective view of a modified receptacle connector 80. As illustrated in FIG. 12, the shape of the mounting legs 42 for mounting the receptacle connector 1 to the circuit board 26 may be modified. The receptacle connector 80 differs from the receptacle connector 1 in that the rearward mounting legs 82 of a shell 84 are of the SMT (Surface Mounting Technology) type, as opposed to the dip type. This is because prying forces, which are likely to be exerted on the front portion during insertion and extraction of the connectors, are less likely to be exerted on the rear portion.

In the exemplary embodiment described above, the press contacting protrusion 54 has a contact portion 54a thereof that is linear, in a direction perpendicular to the insertion/extraction direction 62. However, the contact portion 54a may have a desired length in the direction along the insertion/extraction direction 62, in order to obtain an appropriate engagement holding force.

The engaging protrusions 52 of the spring pieces 46 are arcuate. However, the shape of the engaging protrusions may alternatively be inclines surfaces having comparatively low engagement holding forces.

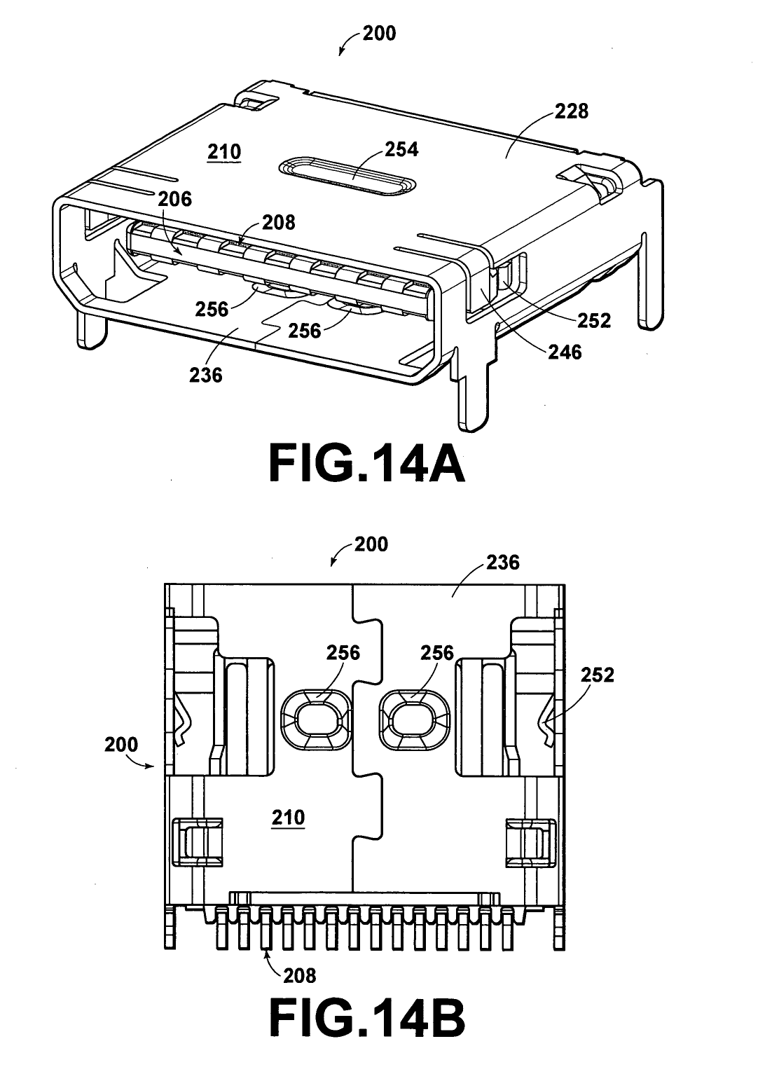

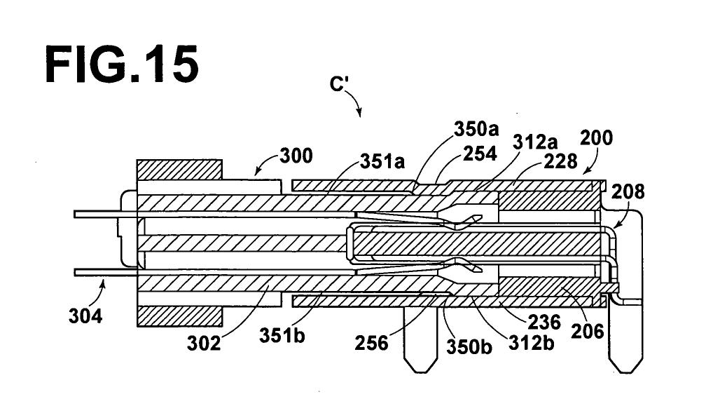

Next, an assembly C′, which has a greater number of contacts than the aforementioned assembly C, will be described with reference to FIG. 13 through FIG. 15. FIG. 13 is a perspective view of a plug connector 300 (second connector), which is a constituent of the assembly C′ (refer to FIG. 15). FIG. 14A is a perspective view of a receptacle connector 200 (first connector), which is to be engaged with the plug connector 300. FIG. 14B is a bottom view of the receptacle connector 200. FIG. 15 is a vertical sectional view of the assembly C′, in a state in which the receptacle connector 200 and the plug connector 300 are completely engaged.

As illustrated in FIG. 13, the plug connector 300 differs from the plug connector 100 in that it has fourteen second contacts 304. The plug connector 300 also comprises steps 350a and 350b, for engaging press contacting protrusions 254 and 256, described later, of the receptacle connector 200. The steps 350a and 350b are formed on the upper surface 312a and the lower surface 312b, respectively, of a housing 302 of the plug connector 300. Note that the steps 350a and 350b will collectively be referred to as steps 350. The step 350a is formed on the upper surface 312a at a position corresponding to that of the press contacting protrusion 254 of the receptacle connector 200. The step 350a is formed as a rearward extending flat surface 351a, which has a width capable of receiving the width of the press contacting protrusion 254. The steps 350b are formed on the lower surface 312b at positions corresponding to those of the press contacting protrusions 256 of the receptacle connector 200. The steps 350b are formed as rearward extending flat surfaces 351b, which have widths capable of receiving the widths of the press contacting protrusions 256 (refer to FIG. 15). The depth of the step 350a is exaggerated in FIG. 13 for the sake of clear illustration thereof. However, the actual depths of the steps 350 are approximately 0.1 mm.

The plug connector 300 comprises engaging protrusions 340 (locking portions), which are formed on locking pieces 306. In this embodiment, they are of the same construction as those of the plug connector 100, so a detailed description thereof will be omitted.

Meanwhile, the receptacle connector 200 to be engaged with the plug connector 300 is of the same basic construction as the receptacle connector 1 of FIG. 1, except that fourteen contacts are provided therein, as illustrated in FIG. 14. That is, a press contacting protrusion 254, which is similar to the press contacting protrusion 54, is formed on an upper wall 228. In addition, two press contacting protrusions 256, which are similar to the press contacting protrusions 56, are formed on a bottom wall 236. The press contacting protrusions 256 are formed at positions corresponding to the steps 350b. The receptacle connector 200 comprises: a housing 206; first contacts 208; a shell 210; spring pieces 246; and engaging protrusions 252 (locking portions). However, as these parts are of the same construction as those of the receptacle connector 1, detailed descriptions thereof will be omitted.

When the plug connector 300 and the receptacle connector 200 are engaged, the press contacting protrusions 254, 256, and 256 engage with the steps 350, as illustrated in FIG. 15. The engagement holding force between the connectors is increased by this engagement. In addition, the “click” of this engagement is combined with the “click” of the locking portions 252 and 340. Thereby, complete engagement can be positively perceived.

What is claimed is:

1. An electrical connector assembly comprising:
a first connector having a first insulative housing for holding at least one first contact;
a second connector having a second insulative housing for holding second contacts that contact the first contact during engagement with the first connector;
locking portions formed on the first and second connectors for locking with each other during engagement with a low engagement holding force; and
protrusions provided on the first connector for frictionally contacting the second connector.

2. An electrical connector assembly as defined in claim 1, wherein:
the first connector includes a metallic shell for containing the second insulative housing, provided at the exterior of the first insulative housing; and
the locking portions comprise spring pieces, which are formed on the metallic shell, and metallic locking pieces, which are provided on the second insulative housing.

3. An electrical connector assembly as defined in claim 2, wherein:
the protrusions protrude from the metallic shell toward the surface of the second insulative housing, during engagement of the first and second connectors.

4. An electrical connector assembly as defined in claim 1, wherein the first and second connectors are engaged in an engagement direction and the protrusions have longitudinal axes that are perpendicular to the engagement direction.

5. An electrical connector assembly as defined in claim 1, wherein:
steps are formed on the surface of the second connector at positions corresponding to the protrusions of the first connector, to engage the protrusions during engagement of the first and second connectors.

6. An electrical connector assembly as defined in claim 2, wherein:
the first and second connectors are engaged in an engagement direction and the protrusions have longitudinal axes that are perpendicular to the engagement direction.

7. An electrical connector assembly as defined in claim 2, wherein:
steps are formed on the surface of the second connector at positions corresponding to the protrusions of the first connector, for the protrusions to engage with during engagement of the first and second connectors.

8. An electrical connector assembly as defined in claim 3, wherein:
the first and second connectors are engaged in an engagement direction and the protrusions have longitudinal axes that are perpendicular to the engagement direction of the first and second connectors.

9. An electrical connector assembly as defined in claim 8, wherein:
steps, for the protrusions to engage with during engagement of the first and second connectors, are formed on the surface of the second connector at positions corresponding to the protrusions of the first connector.

10. An electrical connector assembly as defined in claim 3, wherein:
steps are formed on the surface of the second connector at positions corresponding to the protrusions of the first connector to engage the protrusions during engagement of the first and second connectors.

11. An electrical connector assembly as defined in claim 6, wherein:
steps are formed on the surface of the second connector at positions corresponding to the protrusions of the first connector, for the protrusions to engage with during engagement of the first and second connectors.

12. An electrical connector assembly as defined in claim 7, wherein:
the protrusions have a width, perpendicular to their axes, and frictionally engage the second connector with a frictional force proportional to the width.

13. An electrical connector assembly as defined in claim 7, wherein:
the first connector is a receptacle connector having a shell surrounding the insulative housing with protrusions formed in a top and bottom surface of the shell and facing inwardly.

14. An electrical connector assembly as defined in claim 13, wherein:
the protrusions formed on the top surface and the bottom surface are aligned with one another.

15. A receptacle connector for engaging a plug connector, comprising:
an insulative housing; and
at least one contact held within the insulative housing; wherein:
a metallic shell is provided toward the exterior of the insulative housing;
locking portions are formed on the metallic shell comprising spring pieces, for locking with locking portions of the plug connector during engagement therewith; and
protrusions are provided on the metallic shell, for frictionally contacting the surface of an insulative housing of the plug connector, which is inserted into the interior of the metallic shell.

16. A plug connector for engaging a receptacle connector, comprising:
an insulative housing; and
at least one contact held in the insulative housing; wherein: and
locking portions are provided at the exterior of the insulative housing comprising metallic locking pieces having locking surfaces angled with respect to an insertion direction of the plug connector, for locking with locking portions of the receptacle connector with a low engagement holding force during engagement therewith; wherein
the insulative housing is adopted to frictionally contact protrusions in the receptacle connector when the plug connector is inserted into the receptacle connector.

17. A plug connector as defined in claim 16, wherein:
steps are formed on the surface of the insulative housing, at positions corresponding to the protrusions of the receptacle connector.
